(19) United States
(12) Patent Application Publication
(10) Pub. No.: US 2026/0313266 A1
(43) Pub. Date: Oct. 8, 2026

(54) METHODS AND SYSTEMS FOR REAL TIME ADAPTIVE SCANNING OF MULTIPLE REGION OF INTERESTS WITH VARIABLE FRAME RATES IN IMAGE SENSORS

(71) Applicants: Hussein Ali, Foothill Ranch, CA (US); Rajkumar Chinnakonda Kubendran, Pittsburgh, PA (US); Mehdi Habibi, Lantana, TX (US); Siddharth Advani, New Haven, CT (US); Benoît Michel, Paris (FR); Himanshu Akolkar, Pittsburgh, PA (US)

(72) Inventors: Hussein Ali, Foothill Ranch, CA (US); Rajkumar Chinnakonda Kubendran, Pittsburgh, PA (US); Mehdi Habibi, Lantana, TX (US); Siddharth Advani, New Haven, CT (US); Benoît Michel, Paris (FR); Himanshu Akolkar, Pittsburgh, PA (US)

(21) Appl. No.: 19/465,086

(22) Filed: Jan. 30, 2026

Related U.S. Application Data
(60) Provisional application No. 63/782,752, filed on Apr. 3, 2025.

(51) Int. Cl. H04N 25/779; H04N 25/77; H04N 25/78

(52) U.S. Cl. CPC H04N 25/779; H04N 25/77; H04N 25/78

(57) ABSTRACT

Event-based sensors transfer data asynchronously, focusing on transmitting pixel data that undergo significant illumination changes, which reduces data transfer rates and power consumption compared to conventional frame-based imagers. The proposed architecture allows synchronous operation with the processor, eliminating the need for overhead coordination data, and introduces multiresolution techniques to reduce the number of access cycles required.

### RELATED APPLICATIONS

This application claims the priority of U.S. Provisional Application No. 63/782,752, entitled “METHODS AND SYSTEMS FOR REAL TIME ADAPTIVE SCANNING OF MULTIPLE REGION OF INTERESTS WITH VARIABLE FRAME RATES IN IMAGE SENSORS” filed on Apr. 3, 2025, the disclosure of which is hereby incorporated by reference in its entirety.

### BACKGROUND OF THE INVENTION

Typical image sensors use row scanning decoder, RSDEC, to select rows in pixel array for readout, as shown in FIG. 1. This pixel array may include Asynchronous Dynamic Vision Sensors, Async DVS, or Active Pixel Sensors, APS. The decoder usually changes the scanning pattern based on user input, or intervention from an off-chip processing. Such changes, given their off-chip nature, are too slow to track fast-moving objects in the scene. In addition, the ROIs in the pixel array do not usually adapt its scan rate in real time based on the scene activity, and scanning is usually driving the large load capacitance of the pixel array, resulting in high power consumption, even if the scanned row is not giving new information. The methods and systems described herein are proposing solutions to solve for these challenges.

### SUMMARY OF THE INVENTION

Image sensors usually use row scanning to read the pixel array. This scanning reads one row at a time, and the columns of this row are read in parallel. The read sequence usually follows a predetermined pattern and does not update the sequence in real time. We propose methods and systems to have real time adaptive scanning that corresponds to the scene activity. Regions Of Interests, ROIs, which are the part of the pixel array that show high activity, are scanned, and read at higher frame rate, while other parts of the array are read at slower rate or not read if the user opts to not read. In addition, by using techniques in the pixel array, we propose a system that reduces power consumption of the scanning, by adaptively skipping the scan in rows which show no activity.

The claimed technique includes in-frame adaptive pixel array scanning and readout, which enables row logic and column readout circuits only if the pixels show activity. This results in a significant power reduction in the periphery. In one embodiment, the frame-to-frame adaptive scanning and readout, which may be programmable by the user, is based, at least in part, on the scene activity. This method reduces power, significantly reduces the latency, and permits the tracking of fast-moving objects in real time. The claimed technique may further leverage variable frame rates for different ROIs and achieve low power and higher frame rate by responding in real time to the scene activity.

Advantages of high-speed scanning of the active ROIs, and with well-defined timing, the output data may be reduced in size and complexity, making it possible to transmit changes in the scene with very low latency and with lower data rates. In one embodiment, the Event Activity Detection may be checked on the whole row, tracking multiple objects in the same scene is possible in real time. For example, serializing on multiple lanes to reduce output data rate, and the corresponding bits Unit Interval, UI. In one embodiment, event flag bits may be utilized to disable the corresponding polarity bits output driver, with a rapid on-off driving capability, may further save power. Furthermore, column ROI processing may determine which columns are active, and transmitting this information serially for simple and lower data rate SIPO communication to the digital readout. In one embodiment, variable down-sampling of events, through EDS operation, may be based on the identified ROIs. These ROIs can be selected on a frame-by-frame basis, and down-sampling of data will change accordingly. Accordingly, the Event Activity Detection algorithm is generalized to identify ROIs based on rows and columns activity.

In general, the inventive techniques present an adaptive scanning of the pixel array based on scene activity. According to one embodiment, In-Pixel logic may enable the periphery rows and column circuits only if there is a change in the corresponding pixel rows and columns, and this is done in the context of synchronous scanning by the row circuitry and enables adaptive in-frame low power scanning. The inventive techniques further leverage low latency frame activity detection algorithm, as described in the Event Activity Detection block operation, described below. Furthermore, the claimed techniques utilize variable frame rates of multiple ROIs, based on the scene activity, as described below in the RAP and AP block operation.

An image sensing system for adaptive scanning of regions of interest with variable frame rates includes a pixel array of image sensors arranged in a plurality of rows and a plurality of columns. In one embodiment, the system includes a column readout block receiving a column bus output representing a pixel output from a set of image sensors aligned along a column bus. The adaptive scanning system may also include a row scan decoder in communication with the pixel array of image sensors via a row bus and an address processing block in communication with the row scan decoder and a timing and logic generator block. An event processing unit may be placed in communication with the column readout block and the address processing block. In one implementation, a plurality of output buffers receives a column readout block output and transmits the received column readout block output to a peripheral.

The pixel array of image sensors is preferably comprised of a plurality of asynchronous dynamic vison sensor pixels. The image sensing system may also include an active region of interest detector in communication with the column readout block and the timing and logic generator block. In some embodiments, the timing and logic generator block transmits a plurality of timing signals and a timing and logic generator (TAG) address sequence to the address processing block. The adaptive scanning system may have a user configure the TAG address sequence. The TAG address may also be adaptively determined by the active region of interest detector for intra-frame processing and/or may be adaptively determined by the event processing unit for inter-frame processing.

In one embodiment, the image sensing system may include an event counter receiving an event status bit and an event polarity bit from the pixel array of image sensors, the event counter determining a number of positive events and a number of negative events. The adaptive scanning innovations described herein may also include a serial power interface transmitting a summation of the number of positive events and the number of negative events to an off-chip processor. In some implementations, the off-chip processor transmits a power mode signal to the event processing unit wherein the power mode signal is a wake up signal or a low power signal. The image sensing system may include a row address processing block within the event processing unit, the row address processing block sending one or more timing controls and one or more address sequences to the address processing block. In one embodiment, an event activity detection block is configured within the event processing unit and is responsible for processing a block of pixel rows by analyzing one or more event flag bits.

In some implementations, a pixel array of image sensors may be arranged in a plurality of rows and a plurality of columns. An adaptive row scan enables output may be utilized to represent a row event associated with the pixel array of image sensors along a given row from the plurality of rows. Similarly, an adaptive column scan enables output may be utilized to represent a column event associated with the pixel array of image sensors along a given column from the plurality of columns. The pixel array may further include a column region of interest block identifying a set of columns from the plurality of columns with activity in a scene and a region of interest based events down sampling block configured to perform down sampling based on the set of columns identified with activity in the scene. In one embodiment, the pixel array of image sensors is comprised of a plurality of asynchronous dynamic vision sensor pixels, the plurality of asynchronous dynamic vision sensor pixels each having at least two bitlines, a first bitline for an event status output and a second bitline for an event polarity output. The image sensing system may include a row scan decoder in communication with an adaptive row scan enable, the row scan decoder receiving a timing controls input and an address sequence input. A row logic driver may combine the timing controls input and the address sequence input to generate a row readout enable signal.

A method for adaptive scanning in a pixel array may include determining, by an active region of interest detector, a row scan address sequence based on frame activity within a row enable bus and a column enable bus. The method may further include performing intra-frame adaptive scanning based on a plurality of row enable signals and the row scan address sequence. The adaptive scanning method may also include assigning a first frame rate speed to a first region of interest based on activity in the first region of interest and assigning a second frame rate speed to a second region interest based on activity in the second region of interest. In some implementations, the adaptive scanning method may include receiving a plurality of down sampling inputs, calculating an active column ratio and an active row ratio and generating a down sampling ratio based on the calculated active column ratio and the active row ratio.

According to one embodiment, the plurality of down sampling inputs includes a pixel array size, a region of interest size, and a column bit selection, the pixel array size including a pixel array column size and a pixel array row size, the region of interest size including a region of interest column size and a region of interest row size. In some cases, the method may further include determining a number of column blocks as a ratio of the pixel array column size and the region of interest column size and determining a number of row blocks as a ratio of the pixel array row size and the region of interest row size. The method for adaptive scanning in a pixel array of claim may also include determining a set of active column blocks and a set of active row blocks and disabling read of a set of inactive columns based, at least in part, on the determined set of the active column blocks and the active row blocks.

### BRIEF DESCRIPTION OF THE FIGURES

FIG. 1 illustrates one embodiment of a pixel array for readout.

FIG. 2a illustrates a block diagram according to one embodiment of the system.

FIG. 2b illustrates a block diagram of an event counter according to one embodiment of the system.

FIG. 3 illustrates a logic diagram used according to one embodiment of the system.

FIG. 4 illustrates a logic diagram used according to one embodiment of the system.

FIG. 5 illustrates a block diagram according to one embodiment of the system.

FIG. 6 illustrates a logic diagram of a row scan decoder according to one embodiment of the system.

FIG. 7 illustrates a block diagram of an event processing unit according to one embodiment of the system.

FIG. 8 illustrates a block diagram of a pixel array according to one embodiment of the system.

FIG. 9 illustrates a flow chart according to one embodiment of the system.

FIG. 10 illustrates a block diagram of an event activity detection algorithm according to one embodiment of the system.

FIG. 11 illustrates a flow chart according to one embodiment of the system.

FIG. 12 illustrates a block diagram of an addressing processing map according to one embodiment of the system.

FIG. 13 illustrates a block diagram of a frame timing and address sequence according to one embodiment of the system.

FIG. 14 illustrates a logic diagram for column region of interest processing according to one embodiment of the system.

FIG. 15 illustrates a logic diagram according to one embodiment of the system.

FIG. 16 illustrates a block diagram according to one embodiment of the system.

FIG. 17 illustrates a flow chart according to one embodiment of the system.

FIG. 18 illustrates a block diagram for down sampling according to one embodiment of the system.

FIG. 19 illustrates a block diagram for event activity detection according to one embodiment of the system.

FIG. 20 illustrates a schematic diagram of a system for performing readout of an event-based sensor.

### DETAILED DESCRIPTION OF THE INVENTION

The present invention is described in the following examples, which are set forth to aid in the understanding of the invention and should not be construed to limit in any way the scope of the invention as defined in the claims which follow thereafter.

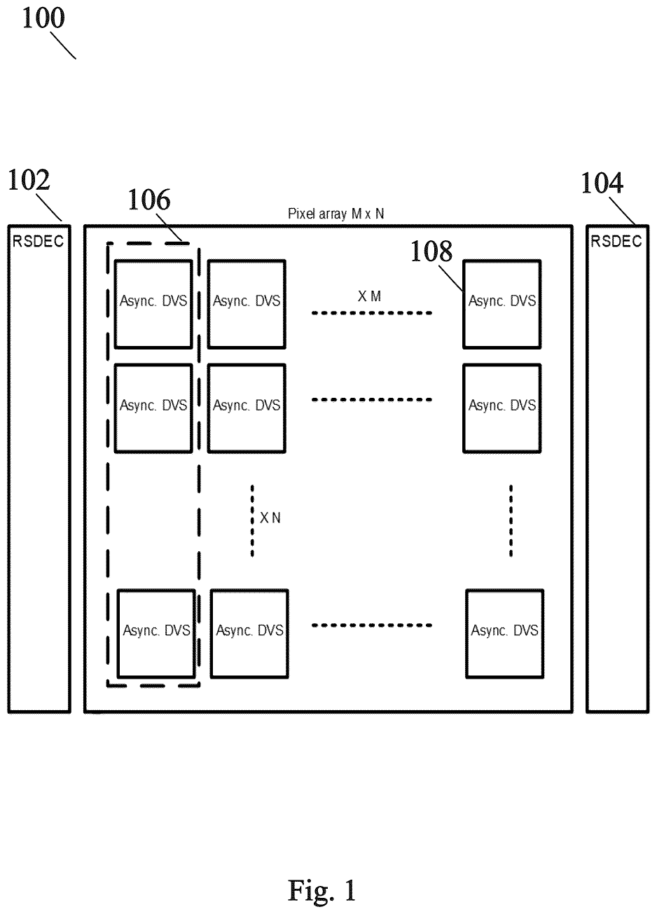

FIG. 1 illustrates one embodiment of a pixel array 100 for readout. As illustrated in FIG. 1, the conventional image sensors use row scanning decoder, RSDEC, to select rows in pixel array for readout. The pixel array 100 includes two row scan decoders, 102, 104 (although operable with a single row decoder), a first column 106 and an asynchronous dynamic vision sensor pixel 108. As illustrated, the pixel array 100, includes an array of M×N asynchronous dynamic vision sensors.

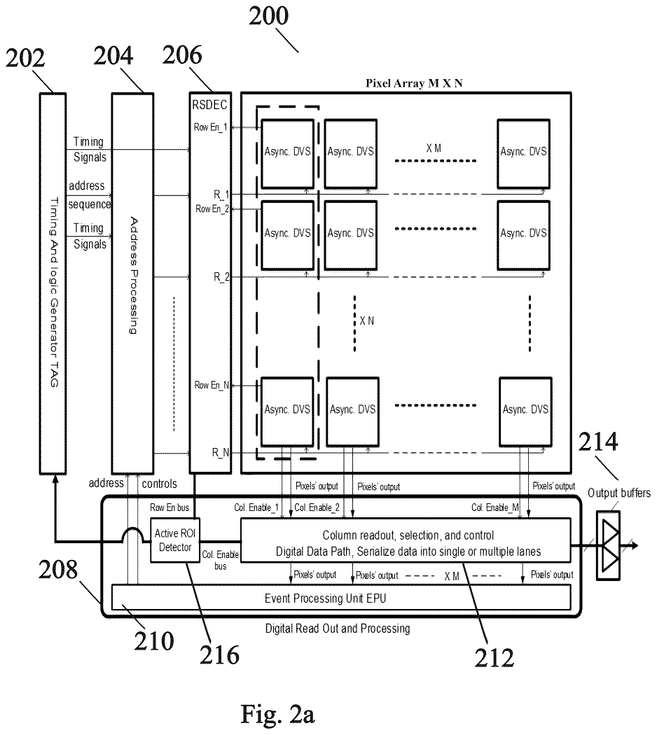

FIG. 2a illustrates a block diagram of a pixel array 200 according to one embodiment of the system. The block diagram includes a Timing And Logic Generator “TAG” 202, an address processing block 204, a row scan decoder RSDEC 206, an M×N pixel array 200, a digital readout and processing block 208, an event processing unit EPU 210, a column readout block 212, one or more output buffers 214, and an Active ROI detector 216.

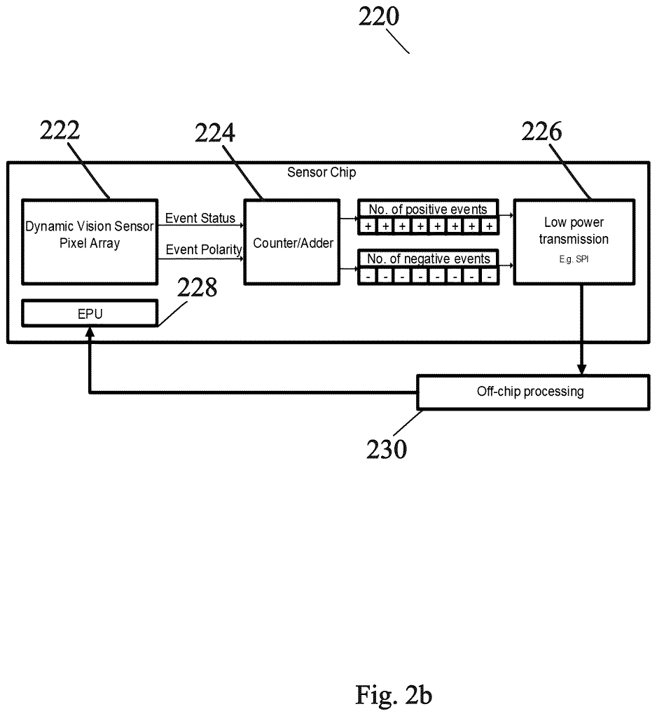

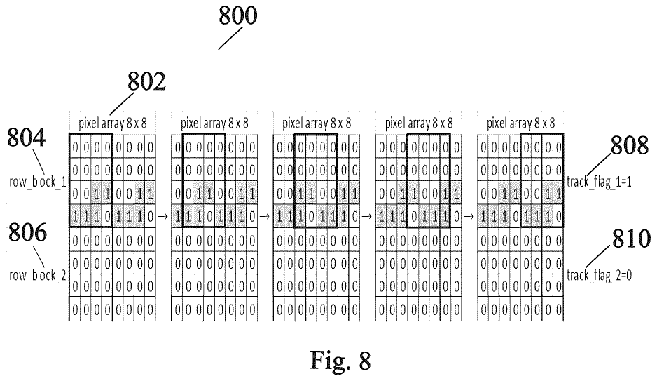

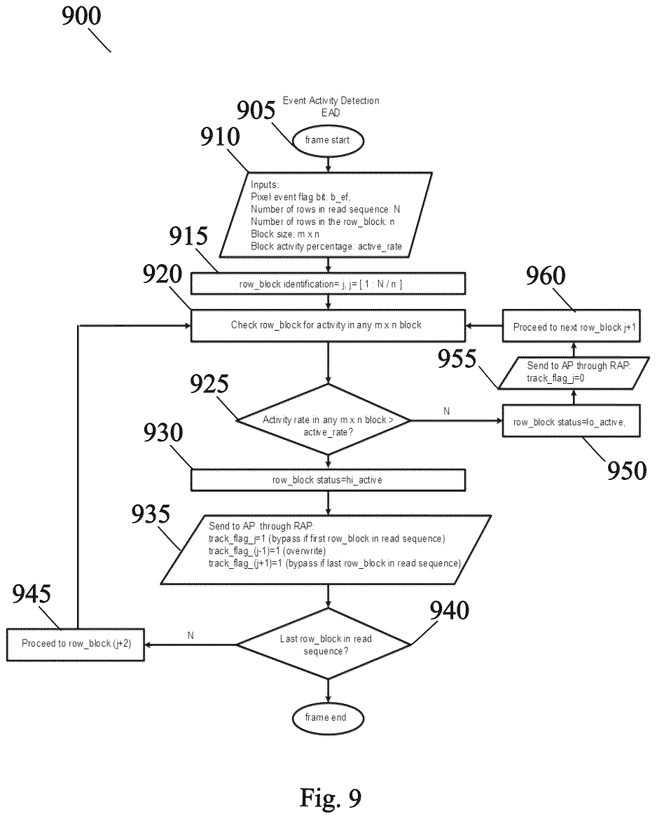

In one embodiment, the adaptive readout system, may accomplish smart scanning in two steps. The first step is intra-frame adaptive scanning, which is done by the row enable signals; Row En_1, Row En_2, . . . . Row En_N and the block ‘Active ROI detector’. The row enable signals disable the row scan if no pixel activity is detected, which reduces the power consumption. The Active ROI detector may determine the row scan address sequence based on the frame activity, which may be determined by the Row En bus (which consists of Row En_1, Row En_2, . . . . Row En_N) and the Col. Enable bus (which consists of Col. Enable_1, Col. Enable_2, . . . . Col. Enable_N). TAG may use the adaptive row and column enable to make row scanning adaptive e.g. disabled if no activity. In one embodiment, the adaptive readout system may check the activity inside the frame (e.g. intra-frame adaptive scanning based on the adaptive row enable 302 and adaptive column enable 304 (reference to FIG. 3), which correspond in FIG. 2 as Row En and Col Enable), and also FIG. 8 and FIG. 9 (FIG. 9 has activity rate in 925) which do adaptive scanning based on activity from frame to frame (e.g. inter-frame). The second step checks the pixel array outputs frame-by-frame, and based on the activity of the scene, faster frame rates are assigned to ROIs that show high activity, while the parts of the pixel array with low activity are scanned at lower rate or skipped if needed. In one embodiment, moderate or high activity may be detected by the processing in the Activity ROI detector block for intra-frame, and the EPU for inter-frame processing. Thresholds for activity may be user defined, based on image intelligence algorithms, and/or the machine learning inference algorithms. The fastest frame rate may be the highest speed possible by the sensor, e.g. in one embodiment the frame rate may is 10,000 frame/second. For low activity ROIs, the lower rate is user-defined, k times slower, e.g. k=10 means 1000 frame/second. An ROI may be programmable by the customers, and/or image intelligence algorithms, and/or machine learning inference algorithms.

The block diagram illustrated in FIG. 2a adds the Event Processing Unit, EPU, closer to the array for minimum latency. For implementation purposes, closer may be understood as on-chip, where it shares the same silicon die with the sensor. Other options are of higher latency, which include having similar EPU processing on the sensor board (called-off-chip solution), or on the cloud (which has the longest latency). This system shows the M×N pixel array, which uses the Async DVS sensors, which produces two bits, one for registering an event, corresponds to a scene change, which is the event flag bit, b_ef, and the other bit determines the direction of change, pointing to either a brighter change or a darker one. The Timing And Logic Generator, TAG, supplies the timing signals and the address sequence of the pixel array. The TAG address sequence is determined by the user, or adaptively by the Active ROI detector block for intra-frame processing (shortest latency and simpler processing), or adaptively by the EPU for inter-frame processing (relatively longer latency, with more intelligent processing). The address sequence is then processed in the Address Processing block, AP, which gives the final address sequence to the scan decoder, Row Scan Decoder (“RSDEC”). The RSDEC scans the pixel array for readout. The Digital Readout and Processing is done at the periphery. The outputs from the pixel array are serialized and sent to the output buffers. The event flag bits are further processed in the Event Processing Unit, EPU, which adaptively changes the readout sequence according to the scene activity for inter-frame processing, and provides updated status to the AP, frame by frame. The AP responds accordingly by scanning only the ROIs of high activity with fastest speed, e.g. 10,000 fps, with the option of scanning the whole pixel array (e.g. ROIs of high activity, plus the remainder of the image plan which has low and/or no activity) one time every k frames.

In one embodiment, k is determined by the user, it could be 10 or 100 or 1000 (e.g. for a sensor with maximum fps of 10 kfps, this translates to 1000 fps or 100 fps or 10 fps). Scanning options may be configured based on the user input, and/or active ROI detector block, and/or the EPU. The EPU could use an event counter for simple and low power processing, as depicted in FIG. 2b. The DVS frames are configured to transmit active ROIs, and dummy ROIs that have low or no activity. Active ROIs represent the tracked parts of the image plane, and it is scanned at high speed. E.g. 10 kfps. Dummy ROIs represent parts of the image plane that are not tracked, and it can use full scan of each row, or skip-scan where some rows are transmitted, and some are not. These dummy ROIs are scanned at the same speed as the active ROIs, or at lower speed, e.g. speed range from 10 kfps down to 1 fps. A counter/adder takes the event status and polarity bits from the DVS pixel array outputs, then it counts the number of positive and negative events per frame. These counts are then transmitted through a low power Interface to the outside of the chip, e.g. through SPI (Serial Parallel Interface). Based on the event counts variation from frame to frame, the off-chip processing might notify the EPU to force the sensor from normal operation into low power mode, or to change the row scanning and/or address sequence of the image plan, or to wake up the sensor from low power mode into normal or high speed scanning.

FIG. 3 illustrates a logic diagram of a pixel array 300 used according to one embodiment of the system. The pixel array illustrated includes an adaptive row scan enable 302 (which are equivalent to row En in FIG. 2a), column scan enable 304 (which are equivalent to Col. Enable in FIG. 2a), a plurality of pixels (one denoted at 310), a plurality of pixel rows XM 320, a plurality of pixel columns XN 330. The RSDEC has row enable inputs, Row En, coming from the pixel array. The column readout has Col Enable inputs as well. These inputs are used to enable the row scan or column readout when there is an event registered, according to the logic in FIG. 3. This logic, which uses OR gates as an example, gives one output per row and one output per column, Adaptive Row Scan Enable 302 and Adaptive Column Enable 304, respectively.

The logic can take other configurations and implementations, with the main idea that a simple logic circuit could be added per DVS pixel, whose output determines if there is event, and then it is combined with the outputs of other similar logic in all the pixels in the rows or columns, so that it gives one output per row which determines if there is an event or more than an event in each row, it gives one output per column which determines if there is an event or more than an event in each column. These outputs enable the row scan or column readout when there is a registered event on the corresponding row or column. This will drastically reduce the power consumption, since the power of the row drivers and the column circuits are cut when there is no activity. If there is no scene activity, the power is mainly consumed by the pixel array. When all the row drivers are disabled, the address sequence coming from the ISP is still scanning, which consumes dynamic digital power. For a 2 Megapixel sensor of 1080 rows, and 7 um pixel pitch, assuming 0.4 fF/um parasitic routing capacitance, and inverter loading in 40 nm CMOS technology, this corresponds to power consumption of less than 95 uW at 10 Kfps, which is negligible with respect to the pixel array static power.

The column readout, selection, and control in FIG. 3 includes the Column Region-Of-Interest Read 360, ROI-Based Event Down Sampling 365, and serialization of event flag bits 380, b_ef, on separate lanes from the polarity bits, b_ed. A Column ROI Processing 370, CRP, identifies the columns which show activity in the scene, and transfers this information to the Column ROI Read through Serial In Parallel Out, SIPO 360. Based on this information, the ROI-Based EDS will do down sampling to reduce the data rate in the transmission lines, ef_serial and ed_serial. The output of the EDS is then separated into multiple lanes, to reduce the data rate per lane. In one embodiment, event_flag bits, b_ef, is distributed into four lanes, and similarly for the polarity bits, b_ed. After serialization, each lane is transmitted off-chip through output buffers.

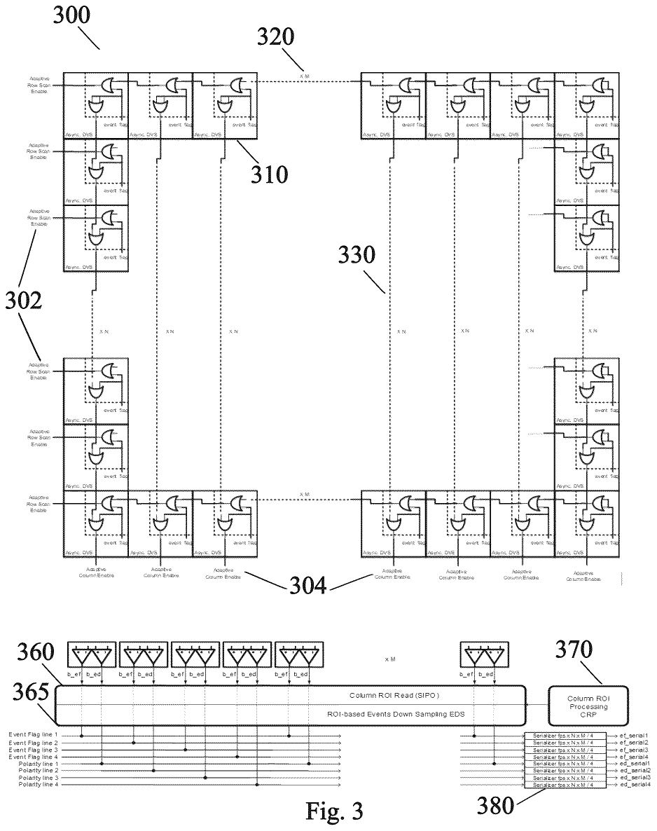

FIG. 4 illustrates a logic diagram of a pixel array 400 used according to one embodiment of the system. The pixel array 400 depicted in FIG. 4 includes adaptive row scan enable 402, adaptive column enable 404, a plurality of rows 420 denoted XM, a plurality of columns denoted XN, an asynchronous DVS 410 in operable communication with neighboring asynchronous DVS 412. FIG. 4 shows an extension of the logic of FIG. 3, to enable the rows and columns when there is more than a single event registered, which could be useful to overcome the intrinsic circuit noise of the sensor. This can be generalized for multiple event detection in the pixel array. This technique enables in-frame adaptive scan for power reduction.

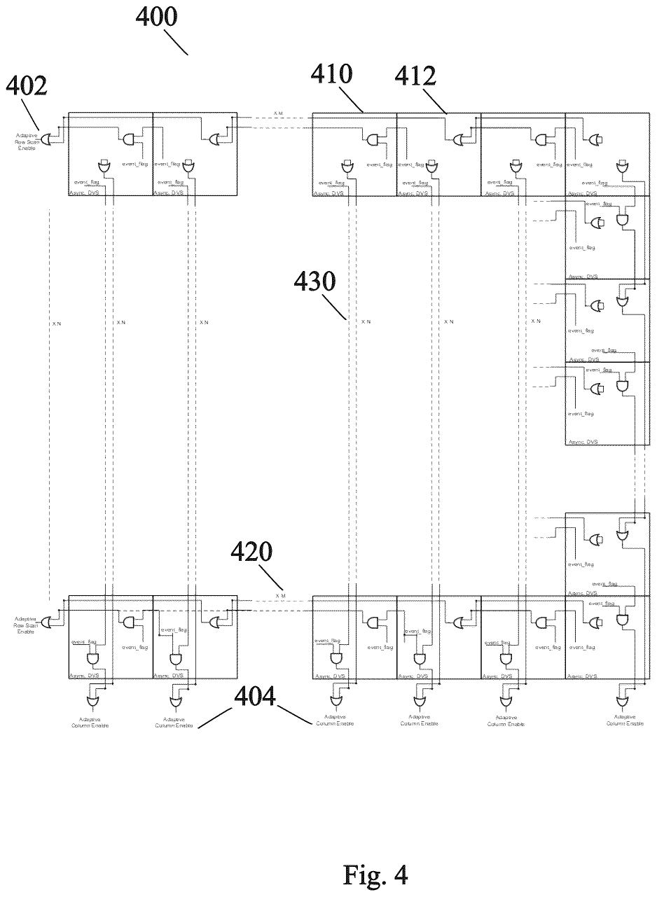

FIG. 5 illustrates a block diagram 500 according to one embodiment of the system. The pixels' output consists of two bitlines; one bitline is for the event status, and the other bitline is for the event polarity. As illustrated in FIG. 5, the block diagram shows column readout. The adaptive column enable 502 is used per column to power down the column sense amplifiers 504 if no activity is registered. Digital path and readout 508 will then report all-zeros, or no activity, if no events in the scene. If there is an event, the event status bit will be active high (logic one), and the adaptive column enable will be active high, this will make the datapath & readout block transmit this event information to the sensor output. In one embodiment, Noise filtering may be handled inside the EPU.

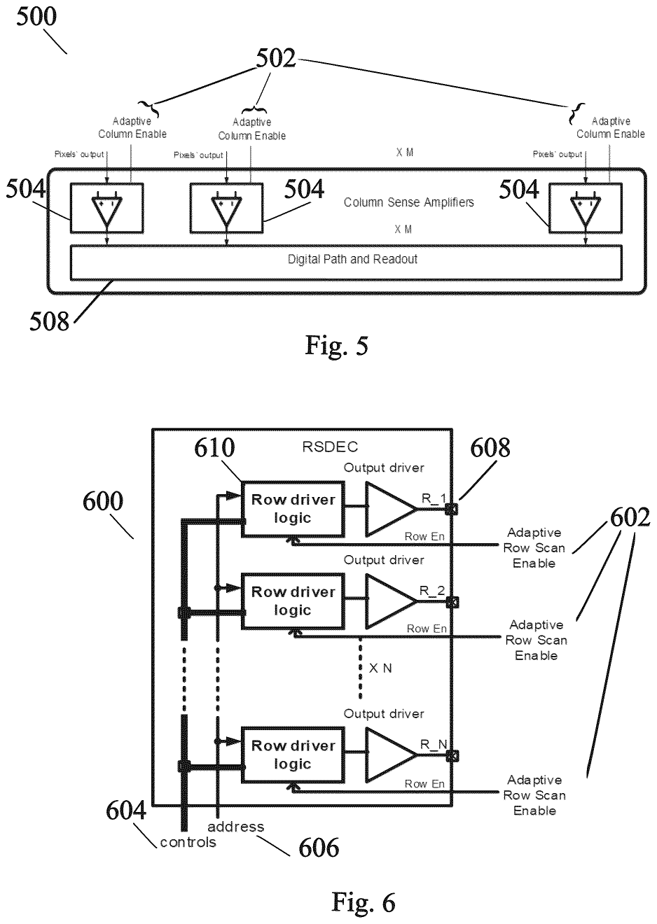

FIG. 6 illustrates a logic diagram 600 of a row scan decoder according to one embodiment of the system. The row scan decoder of FIG. 6 includes a plurality of adaptive row scan enable for each row 602, a timing control(s) input 604, an address sequence input 606, a row logic driver 610 which combines the timing control and address to output the row readout enable signal, and an output driver 608 which buffers the row readout enable signal to drive the large load of the row in the pixel array.

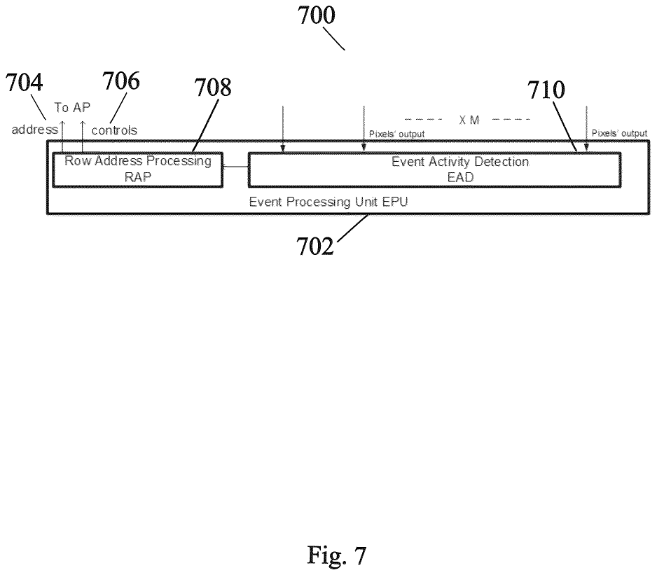

As illustrated, FIG. 6 depicts a simplified diagram of the RSDEC, where the adaptive enable for each row logic is used, and timing controls and address sequence are inputs coming from the TAG. By controlling the address sequence of the RSDEC, and making this sequence adaptive to the scene activity, further power reduction, and higher frame rate in the ROIs of high activity is achieved, and this advantageous method is done by the EPU shown in FIG. 7.

FIG. 7 illustrates a block diagram 700 of an event processing unit according to one embodiment of the system. The illustrated block diagram includes an event processing unit EPU 702, an address output 704, a controls output 706, a Row Address Processing RAP block 708, and an event activity detection EAD block 710. This EPU consists of the Event Activity Detection, EAD, and Row Address Processing, RAP. The EAD may process a block of pixel rows at a time, using their event_flag bits, b_ef. In one embodiment, the EAD may process all the pixels in the sensor, or the pixel rows that are scanned by the RSDEC of FIG. 6. By detecting activity in each row block of n rows, in block windows of m×n, a corresponding track_flag signal is activated, high when there is activity, low otherwise.

FIG. 8 illustrates an example of blocks of pixels 800, according to one embodiment of the system. Each block of pixels is 8×8, which can be programmable to have larger or smaller pixel blocks. The EAD divides the whole pixel array into pixel blocks. The block diagram shows six 8×8 pixel blocks as an example, which are part of the whole pixel array, each pixel block is divided into two row blocks, row_block_1 804, row_block_2 806 and two track flags, track_flag_1 808 and track_flag_2 810. More specifically, FIG. 8 illustrates the EAD algorithm concept, simplified for an 8×8 pixel block, row_block is 4 rows, activity block size is 4×4. As soon as the data of the row block is available from the readout, a search for activity rate above and below certain levels is scanned across the row_block, as shown in the figure. This can be done through combinational logic in one shot. If the activity in one block is within the high and low threshold limits, set by the user and/or system programmable, the track_flag for the corresponding row_block is activated, otherwise, it is set to low. This is repeated to all the row_block in the pixel array. In one embodiment, threshold is percentage e.g. high threshold is 90% and low threshold is 10%, e.g. for 4×4, this corresponds to 2<event number<14. As the EAD scan horizontally across the upper 4×4 blocks, if any block has number of events between 2 and 14, it will set the track_flag=1, otherwise it is 0.

FIG. 9 illustrates a flow chart 900 according to one embodiment of the system. More specifically, FIG. 9 shows the flowchart of the EPU. At frame start 905, the event activity detection may begin. The inputs 910 received by the EPU may include a pixel event flag bit, b_ef, a number of rows in read sequence, N, a number of rows in row_block, n, a block size, m×n, and a block activity percentage, active_rate. The inputs to the EAD could be information regarding the pixel array size, pixel array read sequence, and pixel array outputs, single or multiple activity rate thresholds, pixel block sizes that will be processed, and sequence of processing these pixel blocks. At step 915, the row_block identification is set to j, j=[1: N/n]. This creates a row ID to each pixel block, where n is the number of rows in the pixel block, and N is the number of rows in the whole pixel array. A check may be conducted at 920 to determine if there exists activity within a high and low threshold limits in any m×n block. The EPU may determine whether an activity rate in any m×n block is greater than an active_rate, which is within the high and low threshold limits 925. If the EPU determines the activity rate in any m×n block is greater than an active_rate, the row_block status may be set to hi_active 930. Once the row block status is set to hi_active, outputs 935 may be sent to the address processing block (FIG. 2) through the Row Address Processing Block (FIG. 7). The outputs may include a track_flag for each row block identifications j, j−1 and j+1. The instructions to the AP are to set these row block identifications to 1 unless they are at the beginning or end of a read sequence, otherwise the AP may bypass. The EPU may determine if the last row_block in a read sequence has been reached 940. If it has been reached, the frame is at the end. If it has not been reached the EPU may proceed to row_block+2) 945. When the activity rate for any given m×n block is less than or equal to the active_rate, the EPU may set the row_block status to lo_active 950. The EPU may send an output to the address processing AP block through the Row Address Processing block RAP where the track_flag j=0 955. The EPU will then proceed 960 to the next row block_j+1 and continue to check for activity in the m×n block.

The M×N pixel array is divided into row_blocks. The number of rows, n, in the row_block can be variable, set by the user. For example, for 1920×1080 pixel array, row_blocks could be, for example, 4, 8, 16, 32, 64 rows each. Additional row sizes may be used outside these examples and the number of rows utilized in the row block may increase proportionately to the size of the pixel array. The row block identification defines the number of row blocks, which is N/n. The remainder of the 1080 rows could be added to the first and the last row blocks. The activity block size could be 32×32. So, the algorithm will search for one block of activity rate equal or larger than the threshold of the block activity percentage, active_rate. The activity threshold, active_rate, can be variable, set by the user. For example, active_rate could be 30%. If there is no activity, the corresponding track_flag is set to zero, and the result is sent to the RAP, and the algorithm proceeds to the next row_block. If activity is detected, the corresponding track_flag of the row_block is set to high, as well as the track_flag of the preceding and following row_blocks. This feature can be enabled or disabled by the user. This feature could be useful in tracking fast moving objects, since the positions of the pixels that are active will shift in time to reflect the fast motion, so the following frame will still catch object when it moves to an adjacent row_block. The activity check will proceed to the following row_blocks until the end of the pixel array. This will check the whole pixel array for activity on a frame-by-frame basis and update the RAP block on a frame-by-frame basis.

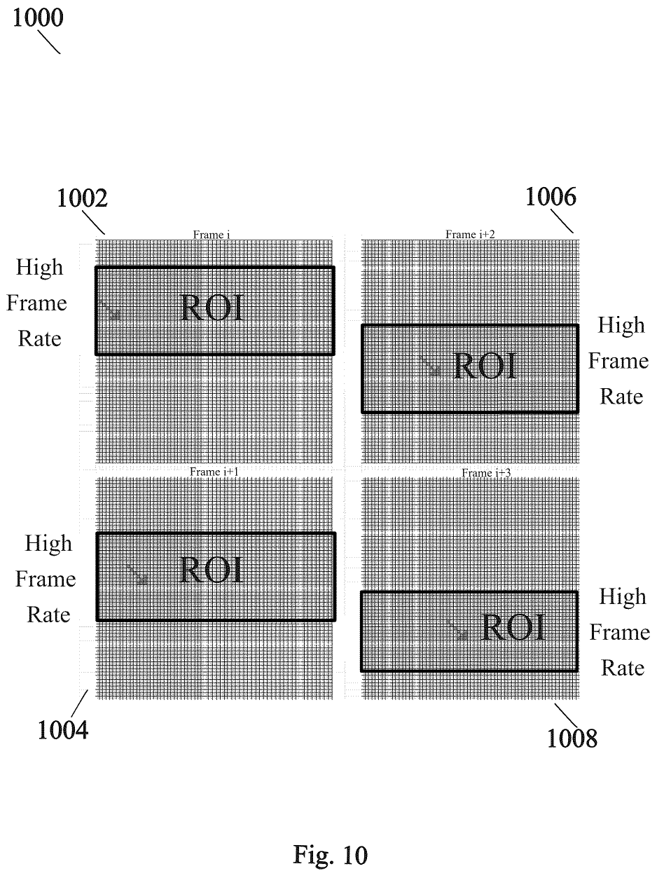

FIG. 10 illustrates a block diagram 1000 of an event activity detection algorithm according to one embodiment of the system. The diagram in FIG. 10 shows four frames, Frame i 1002, frame i+1 1004, frame i+2 1006 and frame i+3 1008. More specifically, FIG. 10 illustrates the EAD tracking algorithm for a fast moving object, e.g. for navigation in space using star tracking, spacecrafts move at speeds higher than 17600 mph. For clarity purposes only, the pixel array is 64×64, and row_block has 8 rows, and the activity block size is 8×8. Pixel arrays may include but are not limited to the following specifications. For example, in mobile devices a sensor may be 12 Megapixels (MP): 4000×3000, 16 MP: 4608×3456, 20 MP: 5120×3840, 48 MP: 8000×6000, 64 MP: 9248×6936, 108 MP: 12000×9000 and/or 200 MP: 16384×12288. In industrial or machine vision sensors, the sensor may be 0.3 MP: 640×480 (classic VGA), 1.2 MP: 1280×960, 2 MP: 1920×1080, 3 MP: 2048×1536, 5 MP: 2592×1944, 8.9 MP: 4096×2160 (4K industrial) and/or 12 MP: 4096×3072. In event-based sensors, the specifications may include array sizes of 128×128, 240×180, 640×480 and to ~1280×720.

As the object moves from ROI in frame i to another ROI in frame i+1, activating adjacent ROIs will help in tracking at high speed, to compensate for the one-frame latency in activity detection. The frame rate using this method could be very high relative to the nominal one. Assume row scanning time is 50 nsec, for 1920×1080 pixel array, this will translate to 18.5 Kfps for the whole array, which is equivalent to a frame latency of 54 usec. Assume adaptive activation for 64×64 row_block, and for three row blocks, this translates to 104.1 Kfps, which is equivalent to a frame latency of 9.6 usec-more than 5× reduction in latency. In some implementations, row scanning time is not variable, ROI is part of the array, and the ROI size is variable—the smaller the ROI size, the faster the scan rate, e.g. for 1080 rows in the pixel array, the latency is 50 nsec×1080=54 usec, for ROI of 64×64, assuming we track 3 ROIs, so the frame now has 64×3=192 rows, so latency=50 nsec×192=9.6 usec.

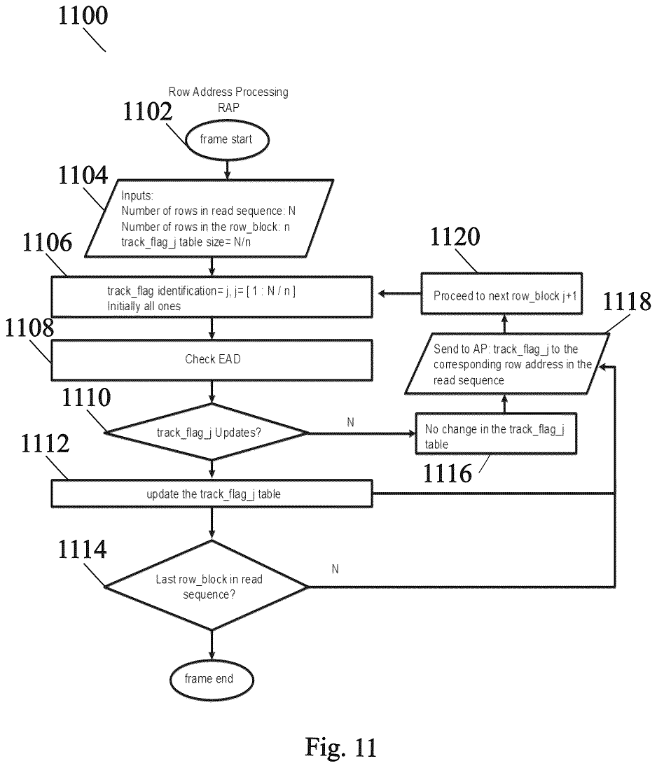

FIG. 11 illustrates a flow chart 1100 according to one embodiment of the system. More specifically, the Row Address Processing (RAP) flow chart is shown in FIG. 11. The RAP is updating the status of the track_flag signals from the EAD, corresponding to each row_block. The RAP passes the updated track_flag table to the AP block. As illustrated in FIG. 11, the RAP begins at a frame start block 1102. The inputs received 1104 by the RAP algorithm include number of rows in read sequence, N; Number of rows in the row_block, n; a track_flag_j table size=N/n. The inputs to the RAP may include information regarding the pixel array size, pixel array read sequence, and pixel array outputs, pixel block sizes that will be processed, and sequence of processing these pixel blocks. In one step 1106, the track_flag identification may be set to j where j=[1: N/n], initially all ones. A check 1108 may be performed on the Event Activity Detection block (shown in FIG. 7). The process may check 1110 if there is any track_flag_j updates. If there are updates, the RAP process may update 1112 the track_flag_j table. The RAP process may check if it is on the last row_block in a read sequence 1114. If it is on the last row block, the frame ends. If there are no updates to the track_flag_j table 1116, the RAP process may send to the Address Processing block the track_flag_j to the corresponding row address in the read sequence 1118. The RAP process may then increment to the next row_block j+1 1120.

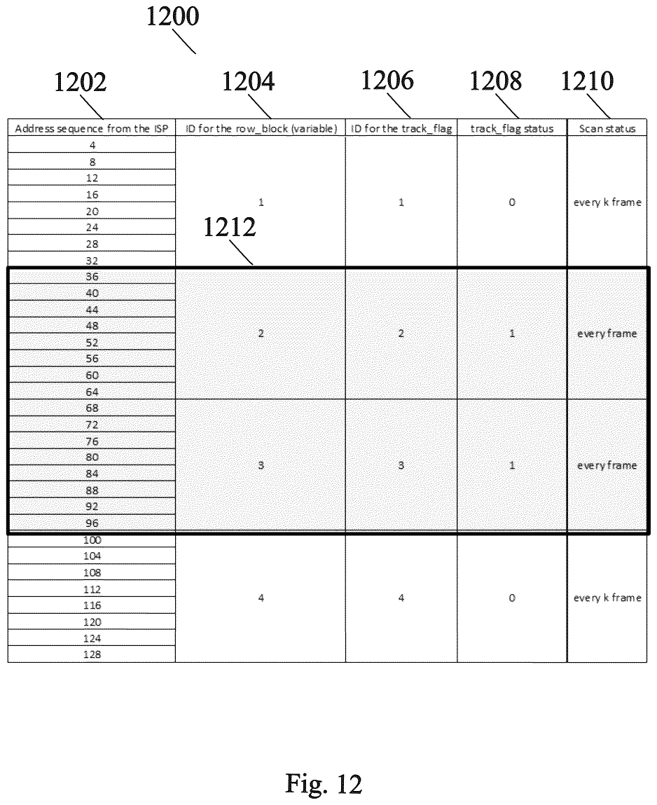

FIG. 12 illustrates a block diagram 1200 of an addressing processing map according to one embodiment of the system. According to the embodiment in FIG. 12, the address processing map may include five columns. The first column may be an Address sequence from the ISP column 1202. The second column may be an ID for the row_block (variable) column 1204. The third column may be an ID for the track_flag column 1206. The fourth block may be a track_flag status column 1208. The fourth block may be a scan status column 1210.

For example, the Address Processing maps any address sequence from the ISP to an associate row_block ID, as shown in the table of FIG. 12. This table is shown as an example for 128×128 pixel array, and skip-4 address read sequence. Assuming row_block has 8 rows, 4 IDs are associated to the read sequence. This maps to a corresponding track_flag ID as well. The track_flag status is updated by the RAP each frame. The AP block passes the address sequence corresponding to the active ROIs (which have track_flag status=1—highlighted in FIG. 12) for readout in each frame to the RSDEC, and each k frame, the AP passes all the address sequence to the RSDEC for readout. This tracks the active ROI with short latency (equivalent to the frame rate, e.g. at 10 kfps, latency is 100 usec), and checks the whole pixel array for additional active ROIs with longer latency (equivalent to the frame rate/k, e.g. 100 fps at k=100, which corresponds to latency=10 msec).

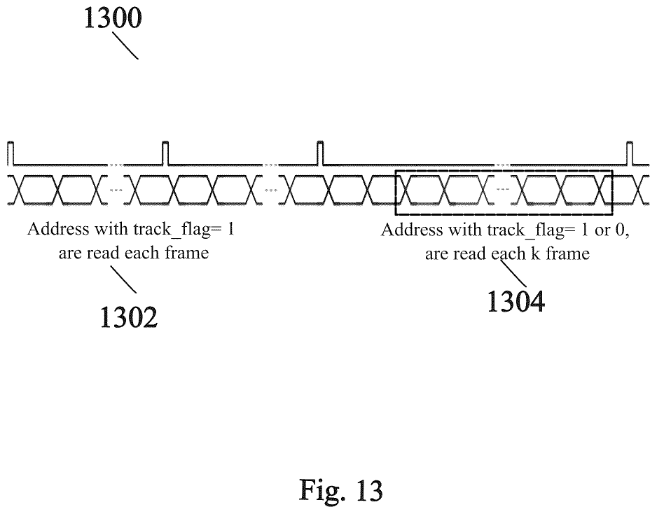

FIG. 13 illustrates a block diagram 1300 of a frame timing and address sequence according to one embodiment of the system. For example, the frame timing and corresponding address sequence is shown in FIG. 13. The AP block updates the timing signals accordingly, for example the frame_start and frame_end signals. According to the diagram, address with track_flag=1 are read each frame 1302. Furthermore, address with track_flag=1 or 0 are read each k frame 1304. In one embodiment, k is a factor that determines how frequently the whole pixel array is scanned/checked relative to the scanning frame rate of the active ROIs.

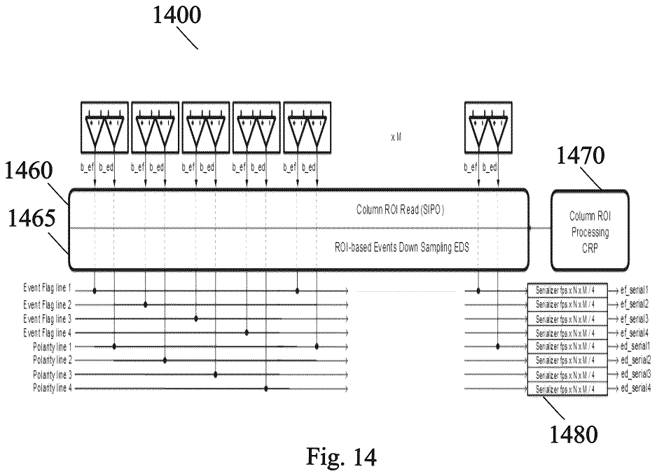

FIG. 14 illustrates a logic diagram 1400 for column region of interest processing according to one embodiment of the system. The column region of interest processing includes the Column Region-Of-Interest Read 1460, ROI-Based Event Down Sampling 1465, and serialization of event flag bits 1480, b_ef, on separate lanes from the polarity bits, b_ed. A Column ROI Processing 1470, CRP, identifies the columns which show activity in the scene, and transfers this information to the Column ROI Read through Serial In Parallel Out, SIPO 1460. Based on this information, the ROI-Based EDS will do down sampling to reduce the data rate in the transmission lines, ef_serial and ed_serial. The output of the EDS is then separated into multiple lanes, to reduce the data rate per lane. In one embodiment, event_flag bits, b_ef, is distributed into four lanes, and similarly for the polarity bits, b_ed. After serialization, each lane is transmitted off-chip through output buffers.

Referring back to the column readout, selection, and control in FIG. 2, the diagram shows the Column Region-Of-Interest Read, ROI-Based Event Down Sampling, and serialization of event flag bits, b_ef, on separate lanes from the polarity bits, b_ed. These are shown in more details in FIG. 14, where a Column ROI Processing, CRP, identifies the columns which show activity in the scene, and transfers this information to the Column ROI Read through Serial In Parallel Out, SIPO. Based on this information, the ROI-Based EDS will do down sampling to reduce the data rate in the transmission lines, ef_serial and ed_serial. The output of the EDS is then separated into multiple lanes, to reduce the data rate per lane. In the Figure, event_flag bits, b_ef, is distributed into 4 lanes, and similarly for the polarity bits, b_ed.

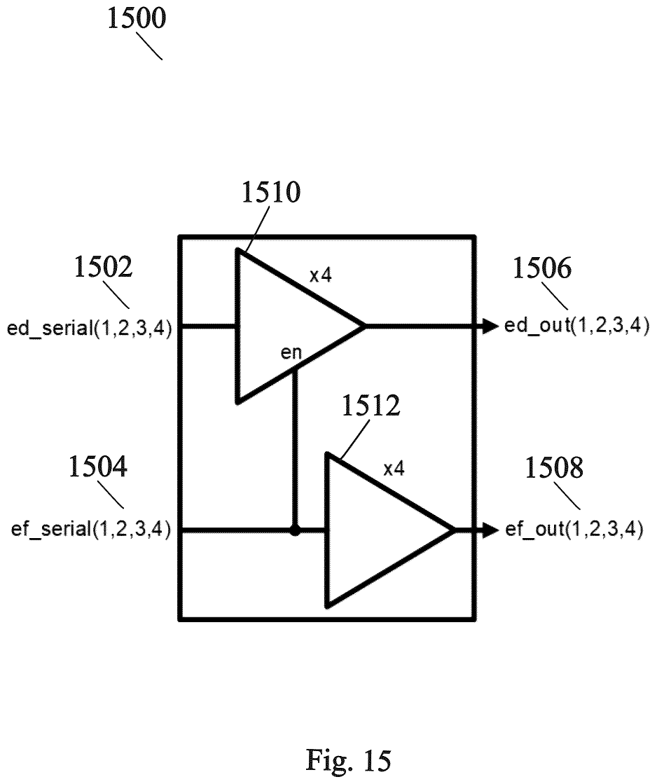

FIG. 15 illustrates a logic diagram 1500 according to one embodiment of the system. The logic diagram shows ed_serial (1, 2, 3, 4) 1502 which represents the serialized polarity bits in lanes 1-4. Additionally, the logic diagram shows ef_serial (1, 2, 3, 4) 1504 which represents the serialized flag bits in lanes 1-4. After serialization, each lane is transmitted off-chip through output buffers, a first output buffer 1510 and a second output buffer 1512, as shown in FIG. 15. The output buffers (1510, 1512) transmit ed_out (1, 2, 3, 4) 1506 and ef_out (1, 2, 3, 4) respectively. The flag bits, ef_serial, can be used to disable the output driver for the polarity bits, if there is no event detected. This can be done using output driver with rapid on and off, in a burst-mode transmission. In one implementation, the flag bits are transmitted off-chip; these are the output of the sensor to the outside world.]

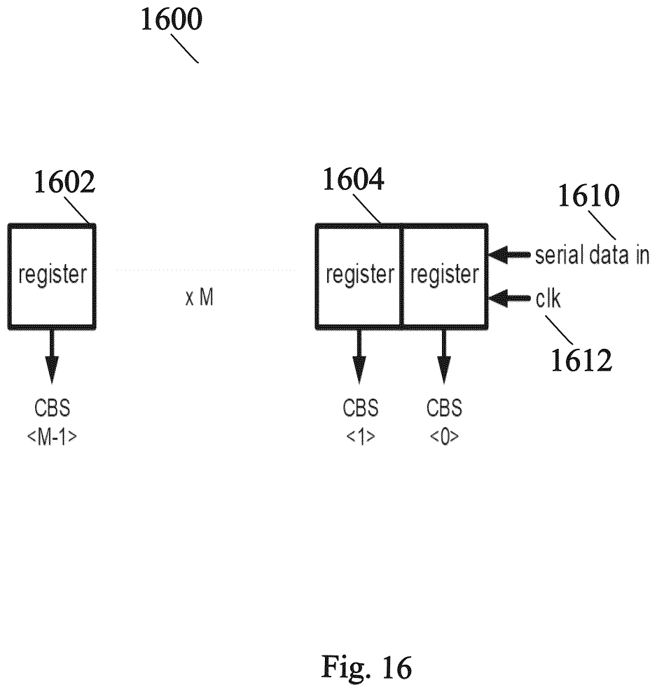

FIG. 16 illustrates a block diagram 1600 according to one embodiment of the system. The block diagram shows a plurality of Column Block Selection (CBS) bits 1602, 1604 (M−1 through 0]. In one embodiment, the CBS<0> bit receives serial data in 1610 and clk or clock data 1612. More specifically, FIG. 16 illustrates an example of the SIPO, where it gets the serial data from the CRP, and distributes this to the column blocks, where each column block will have Column Block Selection bit which decides to enable and read the corresponding columns inside this block, or not to do so.

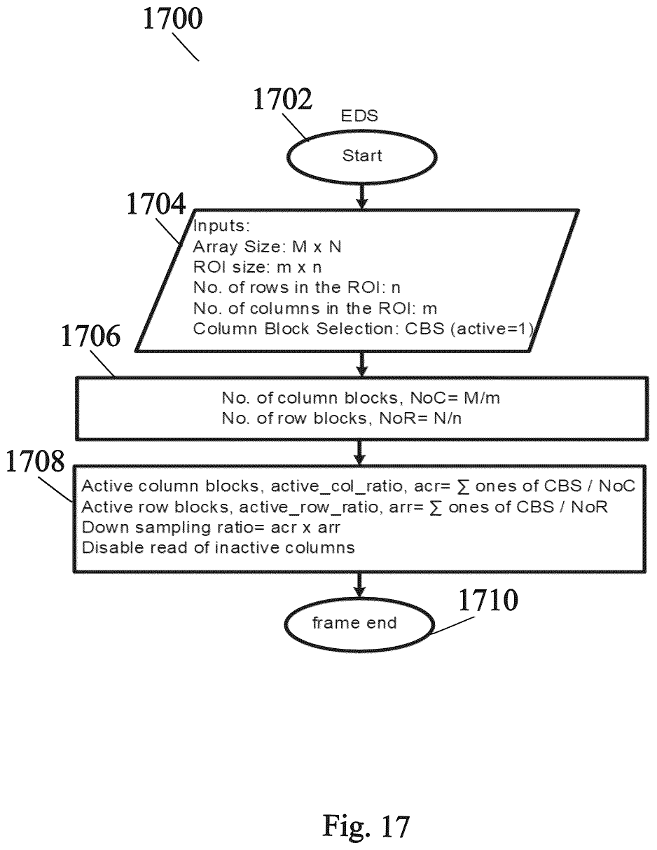

FIG. 17 illustrates a flow chart 1700 according to one embodiment of the system. The flow chart has a start frame for the event down sampling 1702. The inputs received at step 1704 may include an array size of M×N, a region of interest (ROI) size m×n, a number of rows in the ROI: n, a number of columns in the ROI: m, and a column block selection, CBS (active=1). A determination is made at step 1706 for the number of column blocks (NoC) by calculating M/m and the number of row blocks (NOR) by calculating N/n. For example, the down-sampling in the EDS is based on identifying and deciding the down-sampling ratio based on the selection of each column block, as illustrated in the flow chart of FIG. 17. Based on the array and the ROI size, the number of Column blocks, NoC, and the number of row blocks are determined. From the CBS-bit states, activity ratio of the columns and the rows are calculated, active_col_ratio (acr) and active_row_ratio (arr), respectively. As can be seen in step 1708, the active column blocks, active_col_ratio, (acr) may be calculated where

$$acr = Σ Ones of \frac{CBS}{NoC}$$

and the active row blocks, active_row_ratio, (arr) may also be calculated where

$$Ones of \frac{CBS}{NoC}$$

(Ones of CBS are the Column Blocks that have Column block Selection bit enabled.) The process illustrated in FIG. 17 may then proceed to frame end 1710. In one embodiment, the down-sampling ratio is determined, acr×arr. In one embodiment, the down sampling ratio may be used to transmit lower data rate based on the down sampling ratio. The CBS bits are used to disable inactive columns, to save power. For example, where CBS is equal to zero, a message may be sent to the ROI-based Events down sampling EDS (In FIG. 14, 1465) [somewhere] disabling the readout and the transmission of the inactive columns.

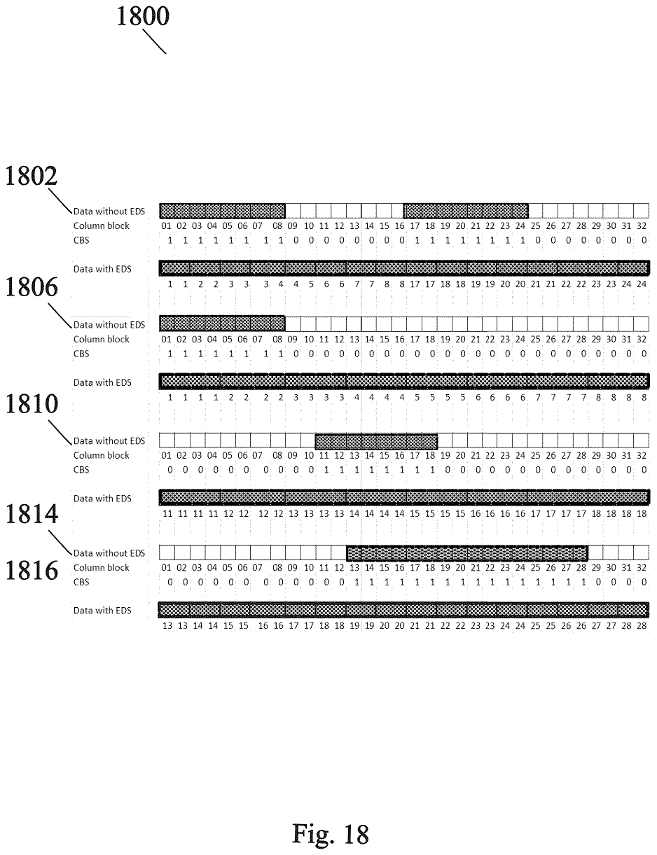

FIG. 18 illustrates a block diagram 1800 for down sampling according to one embodiment of the system. Since the down-sampling ratio is known, and based on the CBS states, an efficient and selective down-sampling can be performed, as shown conceptually in FIG. 18. The digital down-sampling can change the data rate, from frame-to-frame, the Unit Interval of the bit rate is relaxed, based on the EDS function described earlier (the ROI-based Events down sampling EDS (In FIG. 14, 1465), and depicted in FIG. 14 as data with and without EDS. The column blocks with no activity, identified by the CBS=0, may be dropped, and the process may focus on reading the active columns. As can be seen in FIG. 18, the first set of rows 1802 include Data without EDS, a column block identifier, a column block selection bit and data with EDS. The Data without EDS shows 32 column blocks where column blocks 1-8 and 17-24 have a CBS with an active value (or 1). The data with EDS shows the column blocks 1-8 and 17-24 which remain for further processing.

The second set of rows 1804 also includes Data without EDS, a column block identifier, a column block selection bit and data with EDS. The Data without EDS shows 32 column blocks where column blocks 1-8 have a CBS with an active value (or 1). The data with EDS shows the column blocks 1-8 which remain for further processing.

The third set of rows 1806 also includes Data without EDS, a column block identifier, a column block selection bit and data with EDS. The Data without EDS shows 32 column blocks where column blocks 11-18 have a CBS with an active value (or 1). The data with EDS shows the column blocks 11-18 which remain for further processing.

The fourth set of rows 1806 also includes Data without EDS, a column block identifier, a column block selection bit and data with EDS. The Data without EDS shows 32 column blocks where column blocks 13-28 have a CBS with an active value (or 1). The data with EDS shows the column blocks 13-28 which remain for further processing. By focusing on the column blocks shown in data with EDS rows, the process may reduce the demand for power by working at an adaptive and lower data rate, which scales down the data rate based on the ratio of active events/(active events+idle events), increasing the overall efficiency of the sensor.

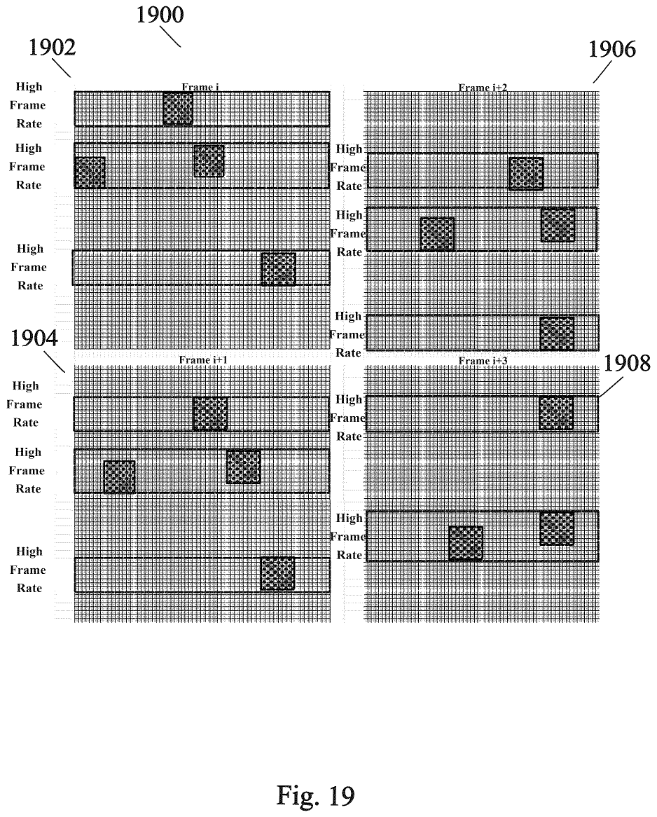

FIG. 19 illustrates a block diagram 1900 for event activity detection according to one embodiment of the system. The block diagram shows four frames Frame i 1902, Frame i+1 1904, Frame i+2 1906 and Frame i+3 1908. The Event Activity Detection algorithm can be extended to include the Column ROI Processing, as illustrated conceptually in FIG. 19. Here, the EAD algorithm will be modified to identify the activity in both rows and columns and then produce the same output control described earlier to track the activity in a frame-by-frame basis. In Frame i, there are four ROIs. In Frame i+1, there are four ROIs. In Frame i+2, there are four ROIs. In Frame i+3, there are three ROIs. The rows or columns with active or high frame rates will continue processing. By limiting the processing to those with activity, many efficiencies may be achieved. For example, the sensor may transmit less data, which facilitates postprocessing, and it makes the processing of the sensor output less expensive in terms of power and memory usage.

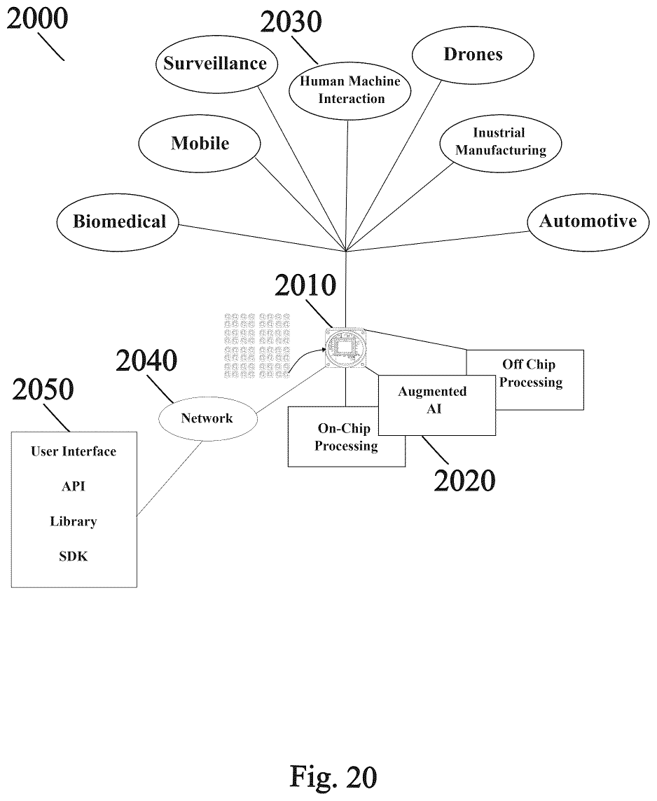

FIG. 20 illustrates a schematic diagram of a system for performing readout of an event-based sensor. FIG. 20 illustrates a schematic diagram of a vision sensor system according to one embodiment. The vision sensor system 2000 depicted in FIG. 20 includes a sensor/array of sensors 2010, a suite of processing blocks 2020, including on-chip processing, augmented AI and off chip processing. The schematic further includes a network 2040 in communication with the sensor/array of sensors and a software stack 2050. The software 2050 may include a graphical user interface, an Application Programming Interface (API), a software library, and a software development kit (SDK). The software may include modules customized to operate in a set of environment specific applications 2030. In one example, the set of environment specific applications may include biomedical, mobile, human machine interaction, industrial/manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

While the foregoing invention has been described in some detail for purposes of clarity and understanding, it will be appreciated by one skilled in the art, from a reading of the disclosure, that various changes in form and detail can be made without departing from the true scope of the invention.

1. An image sensing system for adaptive scanning of regions of interest with variable frame rates, comprising:
a pixel array of image sensors arranged in a plurality of rows and a plurality of columns;
a column readout block receiving a column bus output representing a pixel output from a set of image sensors aligned along a column bus;
a row scan decoder in communication with the pixel array of image sensors via a row bus;
an address processing block in communication with the row scan decoder and a timing and logic generator block;
an event processing unit in communication with the column readout block and the address processing block;
a plurality of output buffers receiving a column readout block output and transmitting the received column readout block output to a peripheral.

2. The image sensing system for adaptive scanning of regions of interest with variable frame rates of claim 1, wherein the pixel array of image sensors is comprised of a plurality of asynchronous dynamic vison sensor pixels.

3. The image sensing system for adaptive scanning of regions of interest with variable frame rates of claim 1, further comprising:
an active region of interest detector in communication with the column readout block and the timing and logic generator block.

4. The image sensing system for adaptive scanning of regions of interest with variable frame rates of claim 1, wherein the timing and logic generator block transmits a plurality of timing signals and a timing and logic generator (TAG) address sequence to the address processing block.

5. The image sensing system for adaptive scanning of regions of interest with variable frame rates of claim 4, wherein the TAG address sequence is user configured.

6. The image sensing system for adaptive scanning of regions of interest with variable frame rates of claim 4, wherein the TAG address sequence is adaptively determined by the active region of interest detector for intra-frame processing.

7. The image sensing system for adaptive scanning of regions of interest with variable frame rates of claim 4, wherein the TAG address sequence is adaptively determined by the event processing unit for inter-frame processing.

8. The image sensing system for adaptive scanning of regions of interest with variable frame rates of claim 1, further comprising:
an event counter receiving an event status bit and an event polarity bit from the pixel array of image sensors, the event counter determining a number of positive events and a number of negative events.

9. The image sensing system for adaptive scanning of regions of interest with variable frame rates of claim 1, further comprising:
a serial power interface transmitting a summation of the number of positive events and the number of negative events to an off-chip processor.

10. The image sensing system for adaptive scanning of regions of interest with variable frame rates of claim 9, wherein the off-chip processor transmits a power mode signal to the event processing unit wherein the power mode signal is a wake up signal or a low power signal.

11. The image sensing system for adaptive scanning of regions of interest with variable frame rates of claim 1, further comprising:
a row address processing block within the event processing unit, the row address processing block sending one or more timing controls and one or more address sequences to the address processing block.

12. The image sensing system for adaptive scanning of regions of interest with variable frame rates of claim 1, further comprising:
an event activity detection block within the event processing unit, the event activity detection block processing a block of pixel rows by analyzing one or more event flag bits.

13. An image sensing system for adaptive scanning of regions of interest with variable frame rates, comprising:
a pixel array of image sensors arranged in a plurality of rows and a plurality of columns;
an adaptive row scan enable output representing a row event associated with the pixel array of image sensors along a given row from the plurality of rows;
an adaptive column scan enable output representing a column event associated with the pixel array of image sensors along a given column from the plurality of columns;
a column region of interest block identifying a set of columns from the plurality of columns with activity in a scene;
a region of interest based events down sampling block configured to perform down sampling based on the set of columns identified with activity in the scene.

14. The image sensing system for adaptive scanning of regions of interest with variable frame rates of claim 13, wherein the pixel array of image sensors is comprised of a plurality of asynchronous dynamic vision sensor pixels, the plurality of asynchronous dynamic vision sensor pixels each having at least two bitlines, a first bitline for an event status output and a second bitline for an event polarity output.

15. The image sensing system for adaptive scanning of regions of interest with variable frame rates of claim 13, further comprising:
a row scan decoder in communication with an adaptive row scan enable, the row scan decoder receiving a timing controls input and an address sequence input;
a row logic driver combining the timing controls input and the address sequence input to generate a row readout enable signal.

16. A method for adaptive scanning in a pixel array, comprising:
determining, by an active region of interest detector, a row scan address sequence based on frame activity within a row enable bus and a column enable bus;
performing intra-frame adaptive scanning based on a plurality of row enable signals and the row scan address sequence;
assigning a first frame rate speed to a first region of interest based on activity in the first region of interest; and
assigning a second frame rate speed to a second region interest based on activity in the second region of interest.

17. The method for adaptive scanning in a pixel array of claim 16, further comprising:
receiving a plurality of down sampling inputs;
calculating an active column ratio and an active row ratio; and
generating a down sampling ratio based on the calculated active column ratio and the active row ratio.

18. The method for adaptive scanning in a pixel array of claim 17, wherein the plurality of down sampling inputs includes a pixel array size, a region of interest size, and a column bit selection, the pixel array size including a pixel array column size and a pixel array row size, the region of interest size including a region of interest column size and a region of interest row size.

19. The method for adaptive scanning in a pixel array of claim 18, further comprising:
determining a number of column blocks as a ratio of the pixel array column size and the region of interest column size;
determining a number of row blocks as a ratio of the pixel array row size and the region of interest row size.

20. The method for adaptive scanning in a pixel array of claim 19, further comprising:
determining a set of active column blocks and a set of active row blocks;
disabling read of a set of inactive columns based, at least in part, on the determined set of the active column blocks and the active row blocks.
